(19) United States
(12) Patent Application Publication
(10) Pub. No.: US 2016/0176263 A1
(43) Pub. Date: Jun. 23, 2016

(54) AIR CONDITIONING SYSTEM FOR TRACTOR TRAILERS

(71) Applicant: David Hutchison, Highland, UT (US)

(72) Inventor: David Hutchison, Highland, UT (US)

(21) Appl. No.: 14/789,874

(22) Filed: Jul. 1, 2015

Related U.S. Application Data
(60) Provisional application No. 62/019,730, filed on Jul. 1, 2014.
(60) Provisional application No. 62/055,282, filed on Sep. 25, 2014.

(51) Int. Cl. B60H 1/00; F24F 13/02; F24F 7/08; F24F 13/10; B60P 3/20; F24F 7/06

(52) U.S. Cl. CPC B60H 1/00378; B60P 3/20; B60H 1/00564; F24F 7/06; F24F 7/08; F24F 13/10; F24F 13/02

(57) ABSTRACT

A cold air diverter system which diverts air-conditioned air from a first chamber to a second chamber is disclosed herein. The cold air diverter system can include an air intake to receive cold air discharged from a cold air outlet configured to cool the first chamber. The cold air diverter system can also include a fluid moving device to be disposed in the second chamber. In addition, the cold air diverter system can include a duct to fluidly couple the air intake and the fluid moving device. The fluid moving device can be operable to convey the cold air from the first chamber to the second chamber via the duct to cool the second chamber. The first chamber can often be a trailer refrigeration unit while the second chamber can be a cabin compartment of a tractor.

### RELATED APPLICATION(S)

This application claims priority to U.S. Provisional Patent No. 62/019,730 filed on Jul. 1, 2014 and U.S. Provisional Patent No. 62/055,282 filed on Sep. 25, 2014, which are each incorporated herein by reference.

### BACKGROUND

Rest stops are generally required during long-haul trips using semi-tractor trailers. Both physical limitations of the driver and various laws can limit the number of hours that a driver can drive on the road. Depending on weather conditions, comfort of the driver during such rest stops can require air-conditioning. Furthermore, truck drivers can be required to rest and sleep 10 hours daily. In order to maintain comfortable conditions while the driver rests and the truck is stopped, the primary tractor engine can be idled or an alternative power unit can be used to power a cooling unit. Some options for powering air-conditioning units include idling and dedicated power units such as diesel generators and alternative power units (APU). APUs can require a separate motor, condenser, evaporator, and fan to cool or heat the sleeping compartment. Specifications for trucks and APU's can vary; however, they can often utilize 200 CFM or more at 36° F. in order to provide adequate cooling. Idling can consume significant amounts of fuel, which increases overall trip costs, and can introduce excessive wear on diesel engines which are not designed to idle for extended periods of time. Thus, attempts at conditioning a cabin or sleeper unit that utilize the tractor air-conditioning system or a refrigerator unit on a refrigerated trailer have been explored. While some attempts to draw conditioned air from refrigerated trailers units have been made, the attempts thus far have presented unique difficulties which have prevented widespread adoption.

### SUMMARY

Accordingly invention embodiments herein provide a cold air diverter system. The cold air diverter system comprises an air intake, a cold air outlet, a first chamber, a fluid moving device, a second chamber, and a duct. The air intake can receive cold air discharged from the cold air outlet to cool the first chamber. The duct can fluidly couple the air intake to the fluid moving device that can be disposed at least in part in the second chamber. The fluid moving device can be operable to convey cold air from the first chamber to the second chamber through the duct.

In one embodiment, the first chamber comprises a refrigeration unit on a refrigeration trailer, the cold air outlet comprises an outlet of a refrigeration unit, and the second chamber comprises the cabin or sleeping unit of a semi-truck.

Also presented herein, is a method of cooling a semi-truck cabin or sleeping unit wherein the method includes diverting cold air from a refrigerator unit on a refrigeration trailer via an air intake to receive cold air discharged from a cold air outlet on the refrigerator unit to the cabin or sleeping unit on the semi-truck via a duct and a fluid moving device, and operating the fluid moving device to pull or draw cold air from the refrigerator unit through the duct and into the cabin or sleeping unit. This system also has strong environmental benefits through eliminating excess greenhouse emissions during engine shutdown rest periods.

There has thus been outlined, rather broadly, the more important features of the invention so that the detailed description that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments and are not, therefore, to be considered limiting of its scope. Furthermore, it will be readily appreciated that the components, as generally described and illustrated in the figures herein, could be arranged in a wide variety of configurations.

FIG. 1 is a schematic illustrating a partial cutaway view of a cold air diverter system in accordance with an example of the present disclosure.

FIG. 2 is schematic illustrating an air intake of a cold air diverter system associated with a refrigeration unit outlet in accordance with an example of the present disclosure.

FIG. 3 is a schematic illustrating a top open perspective view of an enclosure for a fluid moving device and a filter of a cold air diverter system in accordance with an example of the present disclosure.

FIG. 4 is a schematic illustrating a cross-section of a double wall supply and return air duct of a cold air diverter system in accordance with an example of the present disclosure.

FIG. 5A is a schematic illustrating a double wall supply and return air duct end fitting of a cold air diverter system in accordance with an example of the present disclosure.

FIG. 5B is a schematic illustrating a second view of a double wall supply and return air duct end fitting of a cold air diverter system in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

Reference will now be made to exemplary invention embodiments and specific language will be used herein to describe the same. It will nevertheless be understood that no limitation in scope is thereby intended. Alterations and further modifications of inventive features described herein, and additional applications of inventive principles which would occur to one skilled in the relevant art having possession of this disclosure, are to be considered as inventive subject matter. Further before particular embodiments are disclosed and described, it is to be understood that this disclosure is not limited to the particular process and materials disclosed herein as such may vary to some degree. It is also to be understood that the terminology used herein is used for the purpose of describing particular embodiments only and is not intended to be limiting.

### DEFINITIONS

In describing and claiming the present invention, the following terminology will be used.

The singular forms “a,” “an,” and “the” include plural referents unless the context clearly dictates otherwise. Thus, for example, reference to “a baffle” includes reference to one or more of such materials and reference to “diverting” refers to one or more such steps.

As used herein, the term “about” refers to a degree of deviation based on experimental error typical for the particular property identified. The latitude provided the term “about” will depend on the specific context and particular property and can be readily discerned by those skilled in the art. When used in connection with a numerical value, the term “about” is used to provide flexibility and allow the given value to be “a little above” or “a little below” the specific number stated. Further, unless otherwise stated, the term “about” shall expressly include “exactly,” consistent with the discussion below regarding ranges and numerical data.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

In this disclosure, “comprises,” “comprising,” “comprised,” “containing,” “having,” and the like can have the meaning ascribed to them in U.S. patent law and can mean “includes,” “including,” and the like, and are generally interpreted to be open ended terms. The term “consisting of” is a closed term, and includes only the methods, compositions, components, systems, steps, or the like specifically listed, and that which is in accordance with U.S. patent law. “Consisting essentially of” or “consists essentially” or the like, when applied to devices, methods, compositions, components, structures, steps, or the like encompassed by the present disclosure, refer to elements like those disclosed herein, but which may contain additional structural groups, composition components, method steps, etc. Such additional devices, methods, compositions, components, structures, steps, or the like, etc., however, do not materially affect the basic and novel characteristic(s) of the devices, compositions, methods, etc., compared to those of the corresponding devices, compositions, methods, etc., disclosed herein. In further detail, “consisting essentially of” or “consists essentially” or the like, when applied to the methods, compositions, components, systems, steps, or the like encompassed by the present disclosure have the meaning ascribed in U.S. patent law and is open-ended, allowing for the presence of more than that which is recited so long as basic or novel characteristics of that which is recited is not changed by the presence of more than that which is recited, but excludes prior art embodiments. In this specification when using an open ended term, like “comprising” or “including,” it is understood that direct support should be afforded also to “consisting essentially of” language as well as “consisting of” language as if stated explicitly and vice versa. Each term provides support for the others as if expressly stated.

As used herein, “long haul tractor trailer” refers to a tractor and semi-truck trailer combination that is used to carry cargo nationally and/or cross-country. Long haul tractor trailers are generally used to deliver cargo over long distances while including a cabin area or sleeper compartment to allow the operator to sleep or rest as needed.

As used herein, “refrigeration unit,” “reefer,” or “reefer unit” refer to a refrigeration system used to maintain cold air temperatures in a cargo area of a trailer. The refrigeration unit can typically be a self-powered refrigeration unit independent of the tractor engine.

As used herein, “sleeper” or “sleeping unit” refers to a sleeping compartment of a cabin or truck cab. The sleeping compartment can be mounted behind the truck cab, attached to the cab, or incorporated as a part of the cab.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Air Conditioning System for Tractor Trailers

In one embodiment herein, there is provided a cold air diverter system. The cold air diverter system can comprise an air intake, a cold air outlet, a fluid moving device, and a duct. The system can be designed such that the air intake receives cold air discharged from a cold air outlet in a first chamber. The duct can be fluidly coupled to the air intake and the fluid moving device. The fluid moving device can be operable to convey the cold air from the first chamber to the second chamber via the duct to cool a second chamber. In one embodiment, the fluid moving device is disposed at least in part within the second chamber.

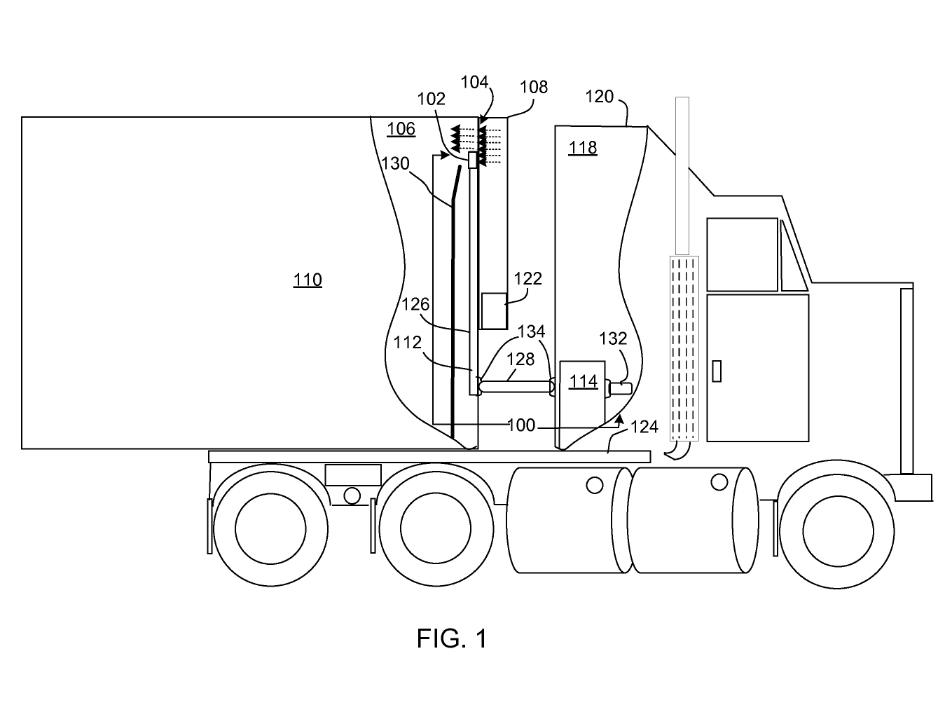

FIG. 1 is a schematic illustration of a cold air diverter system in accordance with one embodiment of the present disclosure. The cold air diverter system 100 can include an air intake 102 that is capable to receive cold air discharged from a cold air outlet 104 configured to cool a first chamber 106 such as from a refrigeration unit 108 (i.e. reefer) oriented at a forward wall of a “refrigeration trailer” 110. The cold air diverter system can be retrofitted to existing refrigeration units by orienting the air intake adjacent the cold air discharge within the trailer compartment. However, in some cases, the cold air diverter can be integrated into the refrigeration unit as a secondary cool air outlet.

The system can also include a fluid moving device 114, such as a pump or fan, to be disposed in a second chamber, such as in a cabin of a truck. The duct 112 can fluidly couple the air intake 102 and the fluid moving device 114. The fluid moving device can be operable to convey the cold air from the first chamber 116 to the second chamber 118 via the duct 112 to cool the second chamber. Thus, in one aspect, the system can be adapted to cool the cabin 120 of the truck using cool or cold air from the refrigeration unit 108.

In a particular aspect, the fluid moving device can “suck” or “pull” air out of the refrigeration unit and direct that air into the cabin or sleeper of a truck. The fluid moving device can be oriented in the first chamber, the second chamber, or in between the second chamber, i.e. anywhere along a diversion path from the refrigeration unit to the cabin and/or sleeper. In one particular embodiment, the fluid moving device 114 can be oriented on the tractor unit 124, and in some cases placed within the cabin or sleeper unit (shown in FIG. 1 as the second chamber 118). In one embodiment, the fluid moving device can be configured to receive power from a power unit 122 of the refrigeration unit 108. Since the refrigeration unit can be operational to keep a perishable load refrigerated, the system can eliminate the need to run or “idle” the truck's engine in order to run the truck's cabin air conditioner for cooling while the truck is parked.

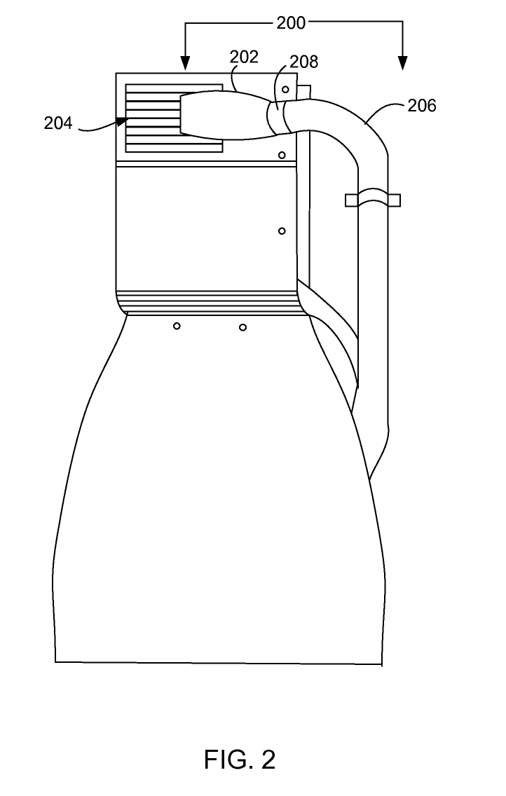

An air intake of a cold air diverter system is schematically shown in FIG. 2. The air intake 200 can comprise an air scoop 202. The air intake can cover a portion of the cold air outlet 204 to collect and direct cold air into the duct 206. In one aspect, this collecting of air directly from the cold air outlet provided by the refrigeration unit can contribute to the volumetric flow rate of air into the cabin, thus aiding the fluid moving device in moving air into the cabin. In another aspect, an adjustable baffle 208 can be associated with the air intake to allow or restrict airflow through the duct 206 according to cooling needs in the truck. The baffle can be controlled by a thermostat or manually controlled by the operator. Thus, when cooling is not needed in the cabin from the reefer, no cooling capacity is removed from the trailer. This can be of benefit when the truck is driven during the daytime in the summer when the cabin is cooled by cabin AC running off a compressor associated with the tractor engine, and the refrigeration unit can be operated to cool the refrigeration trailer without also cooling the cabin. At night, when the outside temperature is lower, the demand on the refrigeration unit is less and cooling capacity from the refrigeration unit can be diverted to the cabin to cool the cabin without using the native cabin AC, thus eliminating the need to run the truck's engine or auxiliary power to cool the cabin.

In one aspect, as shown in FIG. 3, the fluid moving device 300 can comprise an inlet chamber 302, a blower 306, and an air filter 308 oriented within an enclosure 318. The fan size, blower capacity and compartments can vary based on the designers and cabin size.

The air filter 308 can be oriented up stream of the blower 306 and can be used to remove particulates, prevent allergens in the air from entering the cabin, remove odors from the air, and/or to add fragrance to the air. In one embodiment, the air filter can be a carbon filter although fibrous air matte filters can also be used.

Air flow 312 can be directed into the fluid moving device 300 via a second inlet duct portion 310. Air flow through the fluid moving device can be unidirectional passing into the inlet chamber 302, through the filter, and then into the blower before entering the second chamber. In another aspect airflow can be multidirectional, allowing air to be removed from the second chamber. The fluid moving device can include a transition feature 314 to convey air from the fluid moving device to an outlet/third ducting 316. In one embodiment, the transition feature can be a transition cube. The transition feature can be adapted to accommodate various ducting sizes, such as a 2″, 4″, 6″ or 8″ round connection. The transition feature can be connected a third duct portion 316 that can extend from the enclosure 318 of the fluid moving device and into or through the second chamber. In another embodiment, the transition feature and third duct portion can be used to directly tie the fluid moving device to the cabin duct work (not shown) existing in the cabin/sleeper unit via a coupling unit (not shown). In yet another embodiment, the third duct portion can be left unsecured within the cabin/sleeper unit along a flexible duct which is movable such that it can placed or moved within the cabin.

In one embodiment the enclosure 318 surrounding the fluid moving device can be configured to be disposed inside the cabin or sleeper unit of the truck. In another embodiment, the fluid moving device can be configured in a protective casing that can be disposed exterior of the truck cabin and/or sleeper. The enclosure can also be provided with a fastening feature adapted to secure the enclosure to a surface within or on the truck body. For example, tabs, latches, holes or other features can be used to fasten the enclosure to a floor, wall or other fixed feature of the truck. In one specific embodiment the fastening feature can be a mounting bracket to attach with the fluid moving device.

In one aspect, the enclosure 318 can include an opening to receive ambient air from outside of the first and second chambers. The ambient air can either be used alone or in combination with the cool air from the refrigeration unit to provide a desired temperature inside the second chamber. In one embodiment, the enclosure can include a thermostat or thermostat relay 320 that is operable to allow the user to control the temperature within the second chamber. The thermostat can be programmable. In another embodiment, the thermostat can be operable by remote. In yet another embodiment, the thermostat can include a shut off valve that shuts off and/or turns on the fluid moving device respectively when the desired temperature range is reached or the temperature in the second chamber falls outside of a desired temperature range. In another aspect, the thermostat can control operation of one or more baffles 322 that can block airflow through the duct. Thus, the baffle can prevent cold air from reaching the cabin due to pressure from inside the trailer. In one aspect, the baffle can be associated with a duct connection and can be configured to automatically close upon separation of the duct connection and to open when the duct is connected.

In one aspect, the fluid moving device 300 can have multiple speeds to provide a suitable volume of airflow to the truck cabin. In another aspect, the fluid moving device can be configured to substantially match the output of the existing native cooling system of the second chamber. In one embodiment, this output can be about 250 cubic feet per minute (CFM). In yet other aspects the cooling system can be configured to run at about 100 CFM, about 200 CFM, about 300 CFM, about 400 CFM, about 500 CFM, about 600 CFM, about 700 CFM, about 800 CFM, about 900 CFM, or even about 1,000 CFM. The variable output can be based on the fan or blower size and/or a combination thereof. In another aspect this can be accomplished by using a fluid moving device that has the capacity to provide a suitable volumetric flow rates and accommodate losses due to the ducting and/or connections.

In one aspect, the fluid moving device 318 can include a power source 324 that can be used to power the blower. The power source can be located within the enclosure 318 or exterior to the enclosure. In one aspect, powered components of the system, such as the fluid moving device and thermostat, can be configured to receive power from the refrigeration unit, which can obviate the need to use truck power or batteries. Suitable electrical cables or wiring can be included to provide a power connection between the refrigeration unit and the fluid moving device or use existing electrical connections. For example, a jumper between the cabin and the trailer can be used to provide power from the refrigerator unit to the fluid moving device. The jumper can be removably coupled via quick connects or any other suitable removable coupling. In another aspect, the refrigeration unit can also be used to supply power to the cabin or sleeping unit for any other suitable purpose, such as to power appliances, electronics, etc. The system can therefore include any suitable power outlet or coupling feature to facilitate powering auxiliary or miscellaneous items. Accordingly, the refrigeration unit can include an alternator and/or a battery that provides power that can accommodate the refrigeration needs of the trailer, the fluid moving device, and/or any other suitable device that may be powered in the cabin. In other aspects, power can be provided external to the trailer and the cabin to power any suitable device outside the truck and trailer. In another embodiment, the power source can be an electrical outlet. In another embodiment, the power source can be a gas line. In a yet another embodiment, the power source can a chargeable battery device.

The duct can include, as shown in FIG. 1, a first duct portion 126 extending between the air intake and a front wall of the first chamber, a second duct portion 128 extending between the wall of the first chamber and a wall of the second chamber, and/or a third duct portion 132 extending out from the fluid moving device 114. Thus, the second duct portion can extend between the trailer and the tractor unit. Notably, each duct can be provided as a single continuous duct or as multiple segments which are coupled to one another to form a longer duct unit. In one aspect, the second duct portion can be removably attachable to the wall of the first chamber and/or the wall of the second chamber and/or in the middle of the second duct via a coupling unit 134 or feature to facilitate disconnecting duct portions when detaching or switching trailers. The second duct portion can be connected between the truck and another trailer equipped with appropriate ducting, etc. as disclosed herein to cool the cabin of the truck. The duct can comprise a hose or any other suitable type of ducting to convey air between the trailer and the truck. Any suitable hose connection or quick-connect can be used to facilitate connection and disconnection of duct portions as desired. For example, quick-connect couplers can be associated with the trailer and the truck to removably connect with ducting extending between the trailer and the truck. In one aspect, the ducting and connections can be configured to minimize resistance to airflow to maximize effectiveness of the fluid moving device.

In one aspect, the system can also include a protective structure 130 (shown in FIG. 1) configured to protect the duct, duct connections, power cables, etc. from damage inside the first chamber or trailer. For example, the protective structure can provide a bulk head at a distance from a front interior wall of the trailer and the duct can be disposed between the protective structure and the front interior wall. The duct can therefore extend from the refrigeration unit outlet and down the wall to a low position relative to the floor of the trailer where it can pass through the front wall to the truck. In a particular aspect, the protective structure can also be configured to protect the refrigeration unit. The protective structure can therefore protect and shield refrigeration unit components, ducting, and/or, power cables from damage during the loading of pallet supported loads or other type loads into the trailer and/or from damage due to shifting loads during transit. The protective structure can include plates, bars, beams, wire mesh, or any other suitable structural configuration for providing suitable protection for the duct, duct connections, power cables, reefer components, etc.

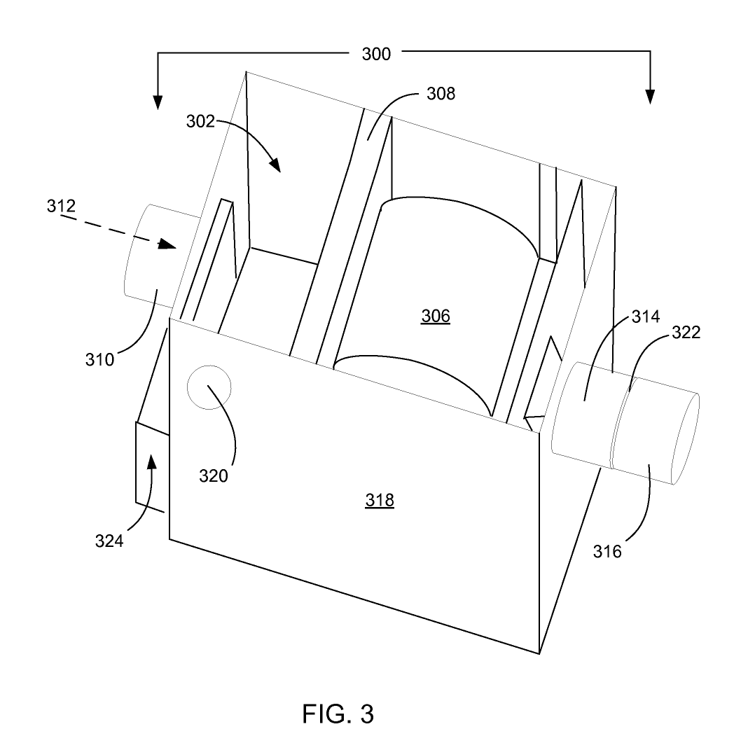

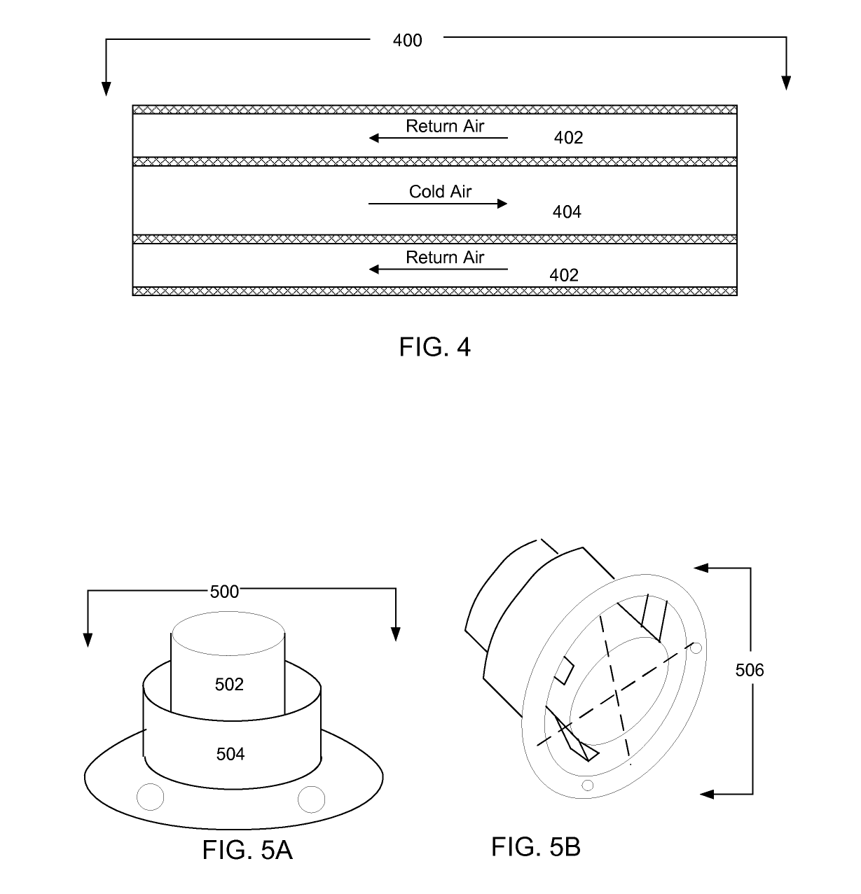

FIG. 4 illustrates the interior of a double wall supply and return air duct 400 of a cold air diverter system in accordance with an example of the present disclosure. For example, the system can include a duct to return air from the cabin to the trailer. This can provide for recirculation of air to balance pressure thereby improving volumetric airflow rate and cooling effectiveness. The return air duct 402 can be associated with at least a portion of the supply duct 404, such as by being disposed about the supply duct. In one aspect, an outer boundary of the supply duct can comprise a circular cross-section and an outer boundary of the return duct can be concentric with the outer boundary of the supply duct. Thus, in one aspect, the return duct can serve to insulate the cold air in the supply duct and/or protect the supply duct from damage. In one example, the outer diameter of the supply duct is 4 inches and the outer diameter of the return air duct is 6 inches. Alternatively, the return air duct and supply air duct can be adjacent non-concentric conduits.

FIGS. 5A and 5B illustrate a double wall supply 500 showing an interior wall 502 and an exterior wall 504 and return air duct end fitting 506 of a cold air diverter system in accordance with an example of the present disclosure. This fitting can be configured to couple the double wall supply and return air duct of FIG. 4 to a wall of the cabin or trailer.

It should be recognized that the cold air diverter system disclosed herein can be provided as original equipment and/or as part of a kit to retrofit a truck and/or trailer. In order to retrofit the cold air diverter system, the air intake can be oriented adjacent the cold air discharge of the refrigeration unit. However, in some cases, the cold air diverter can be integrated into the refrigeration unit as a secondary cool air outlet.

Also presented herein is a method of cooling a cabin and/or sleeper unit of a tractor trailer. The method can comprise diverting cold air from a refrigerator unit on a refrigeration trailer via an air intake to receive cold air discharged from a cold air outlet on the refrigerator unit to the cabin on the semi-truck via a duct and a fluid moving device, and operating the fluid moving device to pull cold air from the refrigerator unit through the duct and into the cabin. The air intake, ducts, and fluid moving device can be as previously described herein.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A cold air diverter system, comprising:
an air intake to receive cold air discharged from a cold air outlet configured to cool a first chamber;
a fluid moving device to be disposed at least in part in a second chamber; and
a first duct to fluidly couple the air intake and the fluid moving device,
wherein the fluid moving device is operable to convey the cold air from the first chamber to the second chamber via the first duct to cool the second chamber.

2. The system of claim 1, wherein the first chamber comprises an interior of a refrigeration trailer, the cold air outlet comprises an outlet of a refrigeration unit, and the second chamber comprises a cabin of a truck.

3. The system of claim 1, wherein the fluid moving device is configured to receive power from a refrigeration unit.

4. The system of claim 1, wherein the fluid moving device comprises a member selected from the group consisting of a fan, a pump, a blower, or combinations thereof.

5. The system of claim 1, wherein the duct comprises:
a first duct portion extending between the air intake and a wall of the first chamber;
a second duct portion extending between the wall of the first chamber and a wall of the second chamber; and
a third duct portion extending between the wall of the second chamber and the fluid moving device.

6. The system of claim 5, wherein the second duct portion is removably attachable to the wall of the first chamber, the wall of the second chamber, or a combination thereof.

7. The system of claim 1, further comprising a second duct to return air from the second chamber to the first chamber.

8. The system of claim 7, wherein the second duct is associated with at least a portion of the first duct.

9. The system of claim 8, wherein the second duct is disposed about the first duct.

10. The system of claim 9, wherein an outer boundary of the first duct comprises a circular cross-section and an outer boundary of the second duct is concentric with the outer boundary of the first duct.

11. The system of claim 1, wherein the first duct is a single continuous duct.

12. The system of claim 1, further comprising a protective structure configured to protect the duct from damage inside the first chamber.

13. The system of claim 1, wherein the air intake comprises an air scoop.

14. The system of claim 1, wherein the air intake covers a portion of the cold air outlet.

15. The system of claim 1, further comprising an air filter to remove odor from the cold air.

16. The system of claim 1, further comprising a thermostat to control temperature inside the second chamber.

17. The system of claim 1, further comprising a baffle associated with the duct to alternately open and close the duct.

18. The system of claim 1, wherein the fluid moving device is disposed in an enclosure having an inlet to couple with the duct and an outlet to direct cold air into the second chamber.

19. The system of claim 18, further comprising a filter disposed in the enclosure to remove odor from the cold air.

20. A method of cooling a cabin on a semi-truck, comprising:
diverting cold air from a refrigerator unit on a refrigeration trailer via an air intake to receive cold air discharged from a cold air outlet on the refrigerator unit to the cabin on the semi-truck via a duct and a fluid moving device, and
operating the fluid moving device to pull cold air from the refrigerator unit through the duct and into the cabin.
